(19) United States
(12) Patent Application Publication
(10) Pub. No.: US 2008/0274306 A1
(43) Pub. Date: Nov. 6, 2008

(54) Stepping Stones Made Of Recycled Material And Related Manufacturing Methods

(76) Inventor: Richard C. Moore, Charleston, SC (US)

Correspondence Address: TURNER PADGET GRAHAM & LANEY, P.A., P.O. BOX 1509, GREENVILLE, SC, 29602, US

(21) Appl. No.: 11/742,809

(22) Filed: May 1, 2007

(51) Int. Cl. B44F 7/00; B28B 1/14

(52) U.S. Cl. 428/15; 264/308

(57) ABSTRACT

Methods of manufacturing multi-colored, rubber steps such as stepping stones and pavers include providing a mold; mixing together a rubber component, a binder and a first coloring agent to form a matrix having a first colored surface; and introducing a second coloring agent onto the matrix to create a multicolored step having a second colored surface opposite the first colored surface.

### BACKGROUND OF THE DISCLOSURE

In order to beautify lawns, gardens and other outdoor grounds, stepping stones such as natural stones, rocks, bricks, molded concrete, and the like are used to create walkways through lawns and around trees, plants, and the like. Stepping stones can present a manicured yet natural appearance while preventing wear and tear to lawns and harm to flower beds due to uncontrolled foot traffic. However, natural stepping stones can be heavy and cumbersome to transport and position and, once in place, can be difficult later to reposition. Furthermore, natural stones can be relatively expensive, especially when creating expansive or multiple walkways.

Mulch may be used as an alternative to stones to create natural appearing walkways. However, mulch typically washes away or blows away or decomposes over time and must be replenished at least seasonally; therefore, over time mulch may not be a cost effective alternative to natural stepping stones. Moreover, mulch tends to stick to shoe soles and undesirably is tracked into homes and buildings, especially if the mulch is wet due to rain or watering.

A further drawback to both natural stones and mulch is color limitation. Stones and mulch can not simply be inverted to reveal a different color if a homeowner desires to change a landscape.

A multi-colored stepping stone is needed in the lawn and garden care industry to offer consumers a greater choice at a reasonable cost.

### BRIEF SUMMARY OF THE DISCLOSURE

The present disclosure is directed in general to multi-colored, synthetic stepping stones or pavers that are used to create natural appearing walkways and paths around trees, shrubbery, flower beds, posts, poles and the like to protect adjacent or nearby lawns and gardens from wear and tear caused by uncontrolled foot traffic.

The multi-colored stepping stones and pavers are made, for example, by recycling a waste product such as used rubber tires. While recycling rubber benefits the environment, excavation of natural stones or stone slabs is also rendered unnecessary, which prevents having to excavate lands and prevents erosion. The multi-colored stepping stones and pavers may be colored brown on one of their sides and red on their opposite sides. Accordingly, a home improvement store, garden store or the like need only use one section of limited floor or shelf space and still be able to offer a choice of at least two colored stones to consumers. Thus, while one consumer may want brown pavers and another consumer may want red pavers, both consumers may each purchase one of the brown-red pavers and simply place the desired color facing up to create their respective walkways. Moreover, where the store had offered previously only a choice of brown and red pavers, each occupying a section of floor or shelf space, the store can now offer another color combination such as pavers having green on one side and black on the other, thus doubling consumer choices in this example to four colors using the same two sections of floor or shelf space.

Evident from the foregoing introduction, the component parts and ingredients of the multi-colored stones and pavers are simple and economical to manufacture and use. Other advantages of the invention will be apparent from the following description and the attached drawings or can be learned through practice of the invention.

According to an exemplary process of the present disclosure, a mold is manufactured to half the desired thickness of the finished product. Rubber is mixed with binder and pigment. The resultant mixture is weighed and placed into the mold then smoothed and leveled in the mold. The compacted mixture is conveyed to a second mixing station, and a ring with an inside diameter equal to the outside diameter is placed over the first mold. The top ring may have a ledge protruding inward to facilitate seating the top ring onto the mold. A second color is poured into the mold, compacted and cured. After curing, the top ring is removed and the finished product extracted from the mold. Finished rings are packaged for shipping and sale.

In producing functionally useful steps, it is also desirable that the steps have a natural aesthetic appearance; i.e., an indigenous stone-like appearance. However, rubber tire particles are typically coal black, while the binder coating them typically is clear, or may be yellowish in appearance. Frequently, such binder/granule mix, when cured, may have an undesirable color and/or sheen or gloss. Accordingly, the disclosure provides a rubber step made from ground-up, waste rubber and a binder, and means for controlling the appearance of the cured step to provide desirable color and aesthetics.

Specifically, to produce steps according to an aspect of the disclosure, a binder (e.g., urethane) is utilized and is mixed together with pigment to provide a desirable color. This binder-pigment mixture is mixed with a catalyst to promote curing and with the ground rubber and fibers. This mixture is then molded into a desired shape and a diatomaceous earth or silica is sprinkled over the uncured mixture to produce a desirable anti-gloss effect in the cured step so produced.

According to one aspect of the disclosure, a rubber step includes a first side being configured for contacting ground, the first side having a first plurality of rubber components configured to appear as a first plurality of pebbles and a first cured color, the first cured color being cured with the first plurality of rubber components; and a second side opposite the first side, the second side being configured for alternative contact with the ground, the second side having a second plurality of the rubber components configured to appear as a second plurality of pebbles and a second cured color different from the first color, the second cured color being cured with the second plurality of rubber components; and a binder holding the respective first and second rubber components together. The rubber step may be a rubber paver, a rubber stepping stone, or other similar natural appearing stone or rock.

In this aspect of the disclosure, the first and second colors may be red, white, brown, green, blue, sandstone, or black, the first color being different from the second color, and the first and second colors being derived from respective coloring pigments.

Also in this aspect, the rubber step may have a thickness of about 0.5 inches to about 1 inch.

Further in this aspect, the rubber components may be rubber granules and may be derived from used rubber tires, although other used and/or natural sources of rubber or other elastomeric materials may be utilized.

In this aspect, the binder may include moisture curable urethane. Also, a curing catalyst and an anti-gloss agent may be used.

The rubber step in this aspect of the disclosure may also include an interlock configured to mate the rubber step with a complementary rubber step.

In another aspect of the disclosure, a method of manufacturing a multi-colored rubber step may include providing a mold; mixing together a rubber component, a binder and a first coloring agent to form a matrix having a first colored surface; and introducing a second coloring agent onto the matrix to create a multicolored rubber step having a second colored surface opposite the first colored surface. The mold may have a height of about one-half inch to about two inches, the height being about half a desired thickness of the rubber step. The mold may also have a diameter of about twelve inches to about forty inches. Further, the mold may have an area of about twelve square inches to about twenty square inches.

In this aspect, the rubber component, the binder and the first coloring agent may be leveled. Also, the rubber component, the binder and the first coloring agent may be cured together, such as by removing moisture from the mixture. The curing may be accomplished by a chemical reaction or simply through ambient drying. Additionally, curing may be accomplished by heat, compression, adhesive, and combinations thereof.

This aspect may also include mixing a plurality of fibers with the rubber component, the binder and the first coloring agent, and may further include mixing a catalyst with the rubber component, the binder and the first coloring agent. Additionally, the second coloring agent may be leveled and cured.

Also in this aspect, the mold may be joined with a ring. The mold may include a peripheral lip and a projection, the projection depending from the peripheral lip. The ring may include a ledge defining a shoulder. The projection and the ledge may be complementarily shaped to seat the ring and the mold together. Also, the first and second colored surfaces may be embossed such as with an embossing roll such that each surface has a different texture.

Accordingly, steps or stones of the composition according to the present disclosure can be used over ground to prevent uncontrolled foot traffic and due to the multiple colors, the products save storage and sales space with one multicolored stone being attractive to different consumers having different landscaping needs.

### BRIEF DESCRIPTION OF THE DRAWINGS

The above and other aspects and advantages of the present invention are apparent from the detailed description below in combination with the drawings, in which:

FIG. 1 is a perspective view of an embodiment of a stepping stone shown in an intended use according to an aspect of the disclosure;

FIG. 2A is a perspective view of the stepping stone as in FIG. 1, particularly showing opposing sides having different colors;

FIG. 2B is a plan view of the stepping stone as in FIG. 2A, particularly showing a granular surface of one side in accordance with an aspect of the disclosure;

FIG. 3A is perspective view another embodiment according to an aspect of the disclosure, particularly showing a paver having opposing sides with different colors;

FIG. 3B is a plan view of the paver as in FIG. 3A, particularly showing a granular surface of one side in accordance with an aspect of the disclosure;

FIG. 4 is a plan view of another embodiment similar to FIGS. 3A and 3B according to a further aspect of the disclosure;

FIG. 5 is a schematic view of a manufacturing line showing a process of forming stepping stones or pavers as in FIGS. 1-4 with different colored opposing surfaces according to another aspect of the disclosure;

FIG. 6 are schematic views of components of the manufacturing line as in FIG. 5 according to another aspect of the disclosure; and

FIG. 7 is a schematic view of alternative portions of a manufacturing line as in FIG. 4 according to another aspect of the disclosure.

### DETAILED DESCRIPTION OF THE DISCLOSURE

Detailed reference will now be made to the drawings in which examples embodying the present disclosure are shown. The detailed description uses numerical and letter designations to refer to features of the drawings. Like or similar designations of the drawings and description have been used to refer to like or similar parts of various embodiments according the disclosure.

The drawings and detailed description provide a full and detailed written description of the disclosure and of the manner and process of making and using various embodiments, so as to enable one skilled in the pertinent art to make and use them, as well as the best mode of carrying out the disclosure. However, the examples set forth in the drawings and detailed description are provided by way of explanation of the disclosure and are not meant as limitations of the disclosure. The present disclosure thus includes any modifications and variations of the following examples as come within the scope of the appended claims and their equivalents.

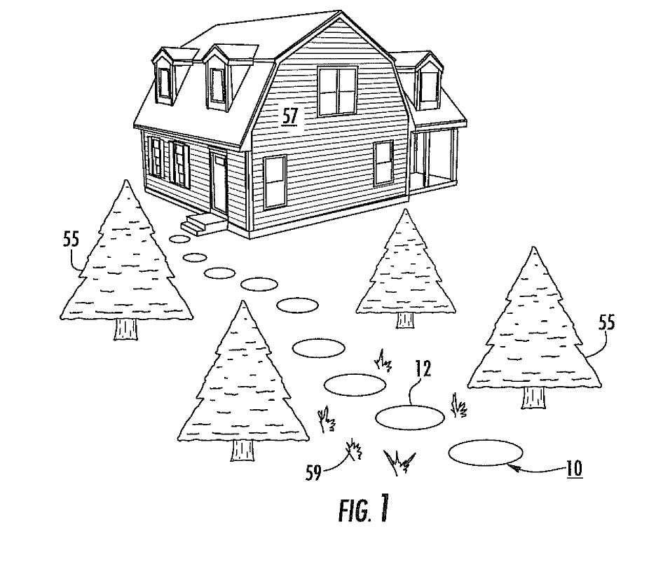

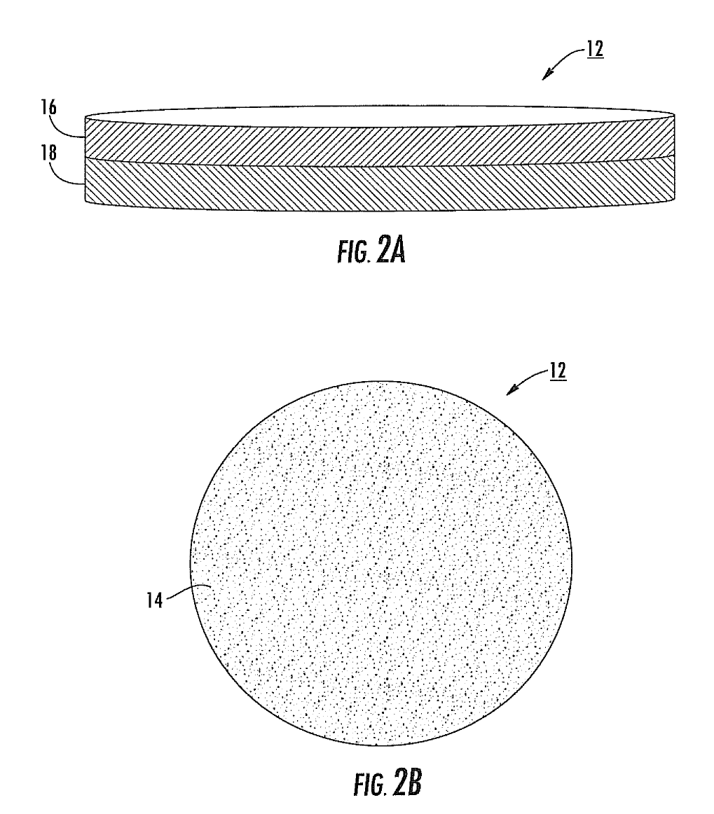

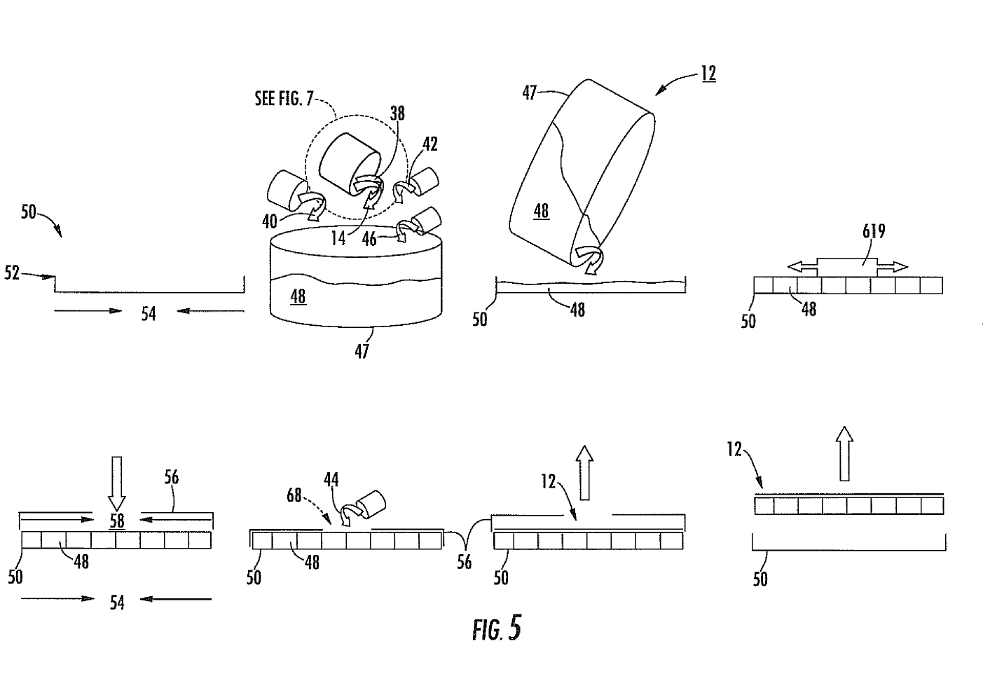

Turning now to the figures, according to one aspect of the disclosure a path or walkway 10 may be formed using a stepping stone, which is designated in general by the element number 12. As broadly embodied in FIGS. 1-2B, the stepping stone 12 may be manufactured by chipping, cutting or chopping used tires, or other recyclable rubber, into granular rubber pieces 14 made to look like pebbles or other small rocks. The granular rubber pieces 14 are combined with a curable binder to form a matrix that is shaped, colored and cured into the stepping stone 12 according to exemplary manufacturing processes as described in detail below with respect to FIGS. 5-7.

With particular reference to FIG. 1, a plurality of stepping stones 12 is shown positioned to form the natural appearing path 10 between and around trees, flower beds, posts, poles and the like, designated in general by the element number 55. In this example, the path 10 of stepping stones 12 leads to a house 57 to protect an adjacent or nearby lawn and/or gardens, generally 59, from wear and tear caused by uncontrolled foot traffic. More particularly, grass 59 in FIG. 1 grows around but not through the stepping stones 12, and pedestrians are invited to walk upon the stepping stones 12 rather than on the grass 59. Since the stepping stones 12 are durable and resilient as described in detail below, mowing or trimming the grass 59 around the stepping stones 12 will generally not harm the stepping stones 12.

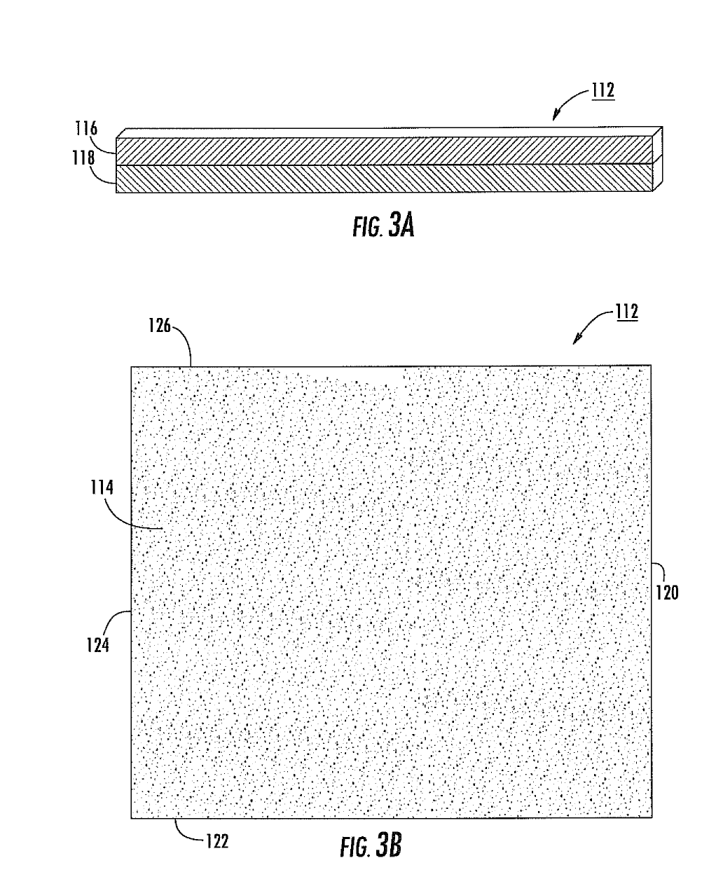

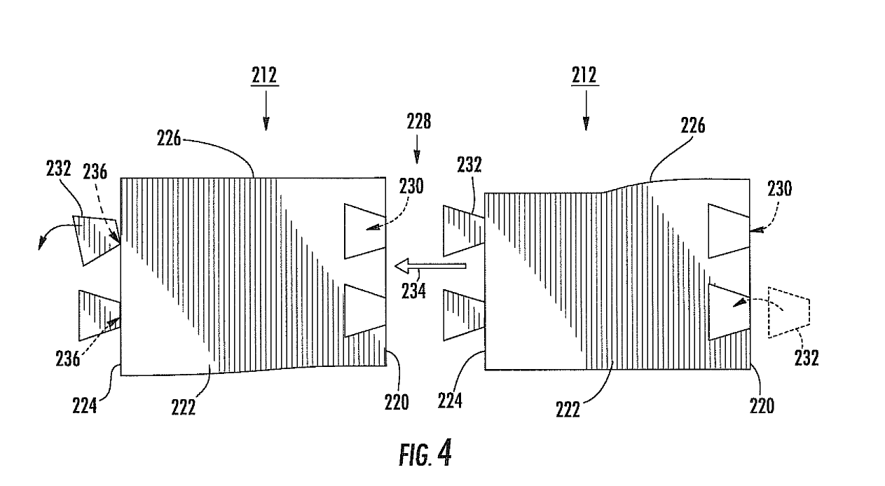

Although each of the stepping stones 12 in FIG. 1 are shown in the shape of a circle, the skilled artisan will appreciate that the stepping stones 12 can be manufactured in a variety of shapes as desired. For instance, FIGS. 3A and 3B show a substantially square-shaped or rectangular-shaped paving stone or paver 112 that may be produced using processes similar to those used to produce the stepping stones 12. Moreover, those skilled in the art will appreciate that the stepping stones 12 and the pavers 112 may be shaped irregularly to imitate natural stones and flagstones. See, e.g., FIG. 4 and related discussion below. Thus, the stones 12 and the pavers 112 are not limited to the exemplary shapes and uses depicted in FIG. 1-3B.

FIGS. 2A and 2B most clearly show that the stepping stone 12 includes an upper or first colored surface 16 and an opposing second or lower colored surface 18. As introduced, either of the surfaces 16, 18 can engage the ground. The choice is simply dependent upon which colored surface the property owner desires to display. The property owner may even wish to display one color one season then turn the stepping stone 12 over during the following season to display the other colored side.

In the example shown in FIGS. 2A and 2B, the stepping stone 12 is about thirteen inches in diameter (13 in. dia.) but may be 14 in. dia. or 16 in. dia. or larger or smaller depending on customer requirements and specifications. Also in this example, the stepping stone 12 is about ½ of an inch to about 1 ½ inches thick but its thickness may be varied as required as further described below with respect to FIGS. 5-7.

As briefly introduced above, mowing or trimming around the stepping stone 12 shown in FIGS. 2A and 2B generally will not harm the stepping stone 12 for at least two reasons. First, the stepping stone 12 is made of resilient rubber which will simply deflect, for instance, a trimming line (not shown). Second, the stepping stone 12 may be depressed into the ground so only one of the colored surfaces 16, 18 is exposed. Accordingly, the exposed surface typically will be relatively ground level or such that blades of a lawnmower, for instance, will pass over the stepping stone 12 without striking the stepping stone 12.

In the example shown in FIG. 2A, the first colored surface 16 is brown in color and the second colored surface 18 is red in color. However, an almost limitless variety of colors and color combinations are within the scope of the present disclosure, and the stepping stone 12 is not limited to the exemplary brown-red combination. For instance, brown-green, brown-black, red-green, red-black and numerous other color combinations and shades of colors can be provided. Also, although natural colors and color combinations that mimic stones, wood, grass and the like are expected in most cases, it is conceivable that some property owners may want peculiar colors (e.g., pink, purple) to compliment a particular motif or to decorate for a special occasion; thus, the possible colors and color combinations for the stepping stone 12 are only limited by consumer imagination. Further details regarding processes for coloring the surfaces 16, 18 are described below with respect to FIGS. 4, 5 and 6.

As briefly introduced above, FIGS. 3A and 3B show the paver 112 as an alternative to the stepping stone 12 described above. In this example, the paver 112 is about twelve square inches (12 in.²) to about 16 in.² and about ½ of an inch to about 1 ½ inches thick but can be made larger or smaller depending on customer requirements and specifications. Like the stepping stone 12, the paver 112 may be made of granular rubber pieces 114 and may be used to form a walkway similar to the path 10 shown in FIG. 1. However, by virtue of substantially straight edges or sides 114, 116, 118 and 120 on each of the exemplary pavers 112, a plurality of the pavers 112 may be abutted against each other to form a continuous walkway in which there are no large gaps between the pavers 112.

With reference now to FIG. 4, irregularly shaped pavers 212 having dual colors and components similar to the previous embodiments may be provided with an interlocking key system or interlock 228. As shown in this example, sides 222, 226 of the pavers 212 may be irregularly shaped for a more natural appearance and side 220 may include one or more indentations or keyholes 230. One or more complementary projections or keys 232 of a side 224 of another paver 212 slide, snap or press-fit into the respective keyholes 230 as indicated by arrow 234. Accordingly, two pavers 212 may be joined together to form a relatively seamless section of a walkway and may be easily separated later to repair or replace the pavers 212, or to reposition the walkway, or to invert the pavers 212 to reveal their alternative color as discussed above.

The skilled artisan will instantly appreciate that although sides 222, 226 of the pavers 212 are irregularly shaped in FIG. 4 but sides 220, 224 are relatively straight (notwithstanding the keyholes 230 and keys 232) any or all sides may be shaped irregularly to mimic natural stones and stone pavers. Moreover, those skilled in the art will appreciate that fewer or additional keyholes 230 and keys 232 may be formed in the pavers 212 and may be used on any or all of the sides 220, 222, 224, 226 to form a patio-type surface or a relatively wider walkway if desired.

FIG. 4 further shows that after the desired number of pavers 212 are laid down and connected together, the keys 232 of the last paver 212 may be snapped or torn off at respective lines of weakness 236. The separated keys 232 may then be used to fill in the keyholes 230 on another paver 212 at an opposing end of the walkway as indicated by the phantom key 232 in order to smooth or otherwise fill-in the opposing end.

Turning now to FIGS. 5, 6 and 7, as briefly introduced above, the stepping stone 12 (as well as the pavers 112, 212) may be made of granular rubber 14, and possibly fibers 38, from used tires 610 or other rubber sources. As described in greater detail below, the rubber 14, the fibers 38, a curable binder 40 (described below), one or more colors (alternatively referred to herein as coloring agents or pigments) 42, 44 and/or a catalyst 46 are mixed together to form a matrix or mixture 48 used to generate the stepping stone 12.

With particular reference to FIG. 5, the stepping stone 12 is produced in this example having a thickness ranging from about one-half inch (0.5″) to about one inch (1″), although other thickness can be produced as noted above. More specifically, a ring or mold 50 is produced as shown in FIG. 5 that is half the desired thickness of the stepping stone 12 as dictated by a top level 52 of the mold 50. Also shown, the mold 50 has a diameter 54 that ultimately dictates a footprint or circumference of the stepping stone 12.

FIG. 5 further shows that the rubber 14 is mixed at a first mixing station 47, with or without the fibers 38, and with the curable binder 40, the coloring agent 42 and/or the catalyst 46 to form the mixture 48. The mixture 48 is weighed and placed into the mold 50 then smoothed with a smoothing device 619, or manually leveled, substantially even with the top level 52 of the mold 50. As shown, the compacted mixture 48 is conveyed to a second mixing station where a second or top ring or section 56 having an inside diameter 58 equal to the outside diameter 54 of the mold 50 is placed over the mold 50.

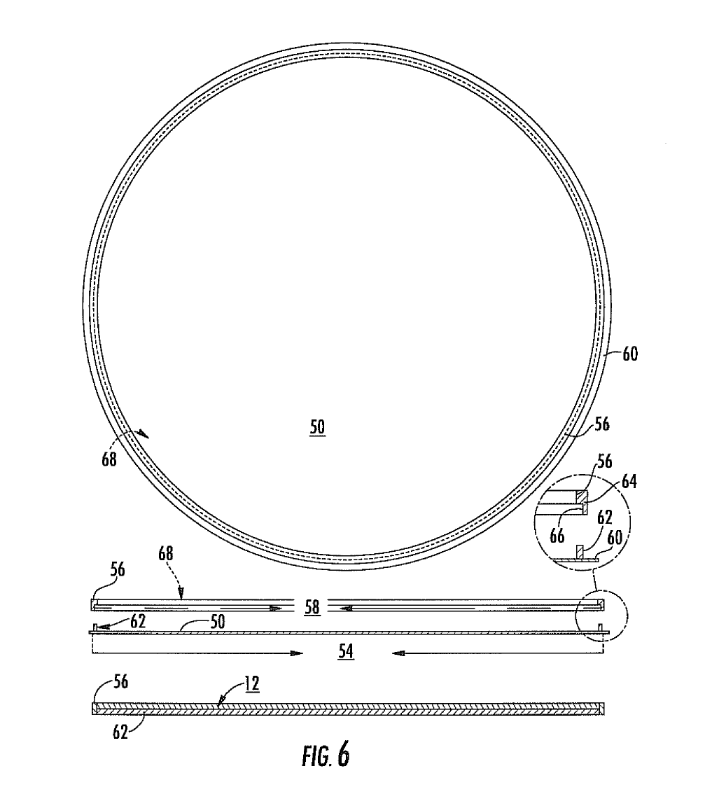

FIG. 6 most clearly shows that the mold 50 may have a peripheral lip 60 from which a projection or anchor 62 projects. The top ring 56 may have a complementary or compatible ledge or projection 64 protruding inward to define a shoulder 66. As shown, the anchor 62 and the ledge 64 seat together to seat the top ring 56 onto the mold 50.

Turning again to FIG. 5, the second color 44 is poured into the mold 50 through, for instance, a hole or opening 68 in the top ring 56 and onto the mixture 48, which has assumed the color of the first color 42. With brief reference once more to FIG. 6, the opening 68 is shown substantially equal in diameter to an inside diameter of the mold 50 to easily spread and compact the second color 44 onto the mixture 48. However, the opening 68 can be smaller such as shown schematically in FIG. 5. If the opening 68 is relatively smaller, other means such as vibration can be employed to spread the second color 44 onto the mixture 48.

As further shown in FIG. 5, the second color 44 and the mixture 48 are cured. Afterwards, the top ring 56 is removed and the finished product—the stepping stone 12 in this example—is extracted from the mold 50. Finished stepping stones 12 are then packaged, such as in shrink wrap, for shipment to stores.

Alternative means of providing different colored surfaces 16, 18 include painting one or both of the surfaces 16, 18 after the mixture 48 has cured. However, paint has been found to dry around individual fibers of the stepping stones 12, leaving black-appearing open spaces and thus, a less natural appearance. Paint also has a tendency to chip or peel away after prolonged exposure to weather and wear.

Another alternative coloring means is to form two separate stepping stone components each having different colors. After curing, the two components may be glued or heat-pressed together using, for instance, a urethane bond. However, this multi-coloring alternative is more expensive than other methods described herein and may result in a lower grade product that is more susceptible to separation.

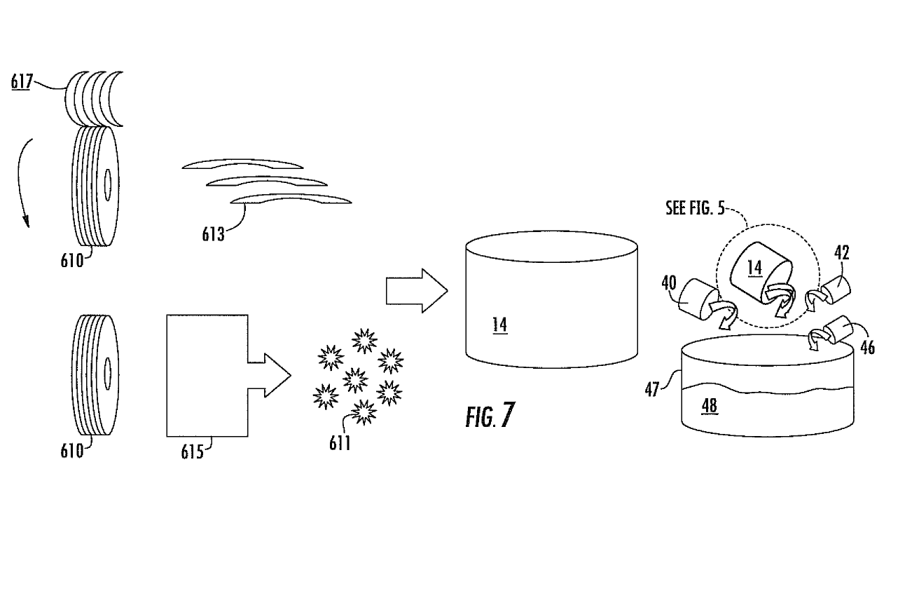

With reference now to FIG. 7, the rubber 14 in the mixture 48 can be obtained from used tires 610 in the form of granules 611 or buffings 613. As shown, the granules 611 are generally in the range of about ⅛ inch to about ¾ inch in major dimension. For instance, when the used tires 610 (or retread pieces) are ground in a granulator 615, steel components are removed, leaving the rubber granules 611. If buffings 613 are desired in the final product, a buffing machine 617 is rotated about the tire 610 (or vice versa) shedding generally finger-like buffings 613 (e.g., about 0.5 inches to about 3 inches in length and about 0.25 to about 1 inch in width). Either or both the granules 611 and the buffings 613 can be used in the mixture 48, although it has been discovered that granules 611 provide the stepping stone 12 a relatively more natural pebble-like appearance.

If rayon, nylon or other such materials were used in the tires 610, the discrete fibers 38 of such materials, about one inch or less in length, may also be a byproduct of shredding, mulching, granulating or buffering the tires 610. More specifically, the general range of ratios of all stepping stone materials by weight is from about 9 or 10 to about 4 or 5 to 1 with the preferable ratio being about 8 to 1. The voids to solids volumetric weight ratio is about 1 to 1.

With reference to both FIGS. 5 and 7, as introduced above, the foregoing materials are mixed with the appropriate, curable binder 40 such as latex or a urethane binder. One suitable binder for use as the curable binder 40 is moisture curable, polyurethane, #2040, manufactured by the ICI Polyurethane division of ICI Americas Inc.

As noted above, the finished product 12 should be as natural in appearance as possible. Accordingly, color and sheen are controlled. The coloring agents 42, 44, briefly introduced above, may be an iron oxide pigment, No. 4701, manufactured by PDI of ICI Americas, Inc., or any other suitable pigment. To control sheen or gloss for a more natural-like appearance, the coloring agents 42, 44 may include an anti-gloss agent, or a separate agent such as diatomaceous silica, such as celite #499 manufactured by Manville Filtration and Minerals, may be used. The diatomaceous silica is, for instance, sprinkled on the surface of the uncured, molded mixture 48 to provide an anti-gloss effect. The skilled artisan will appreciate that any suitable pigment and anti-gloss additives may be used.

Finally, as shown in FIGS. 5 and 7, the catalyst 46, briefly introduced above, is used as needed. An exemplary catalyst for use as the catalyst 46 is Dabco No. T-12 manufactured by Air Products and Chemicals Company.

By way of example, the final mixture 48 by weight may be about 75% to 77% rubber granules 611; 12 to 14% rubber buffings 613; about 0 to 2% fiber 38; about 11% binder 40; about 2 to 5% coloring agent 42, 44 by weight of total binder; about 0.01 to 0.03% catalyst 46 by weight of total binder; and about negligible percent U.V. light stabilizers and anti-oxidants. Such a mixture 48, when cured, weighs about 1.25 grams per cubic centimeter, and has a solids-to-voids volumetric ratio of about 5 to 1. Of course, this ratio can be adjusted by varying the sizes of the rubber granules 611 and/or the rubber buffings 613. For example, an increase in particle size will generally provide more air volume while a decrease in particle size will generally provide less air volume.

While preferred embodiments of the invention have been shown and described, those skilled in the art will recognize that other changes and modifications may be made to the foregoing examples without departing from the scope and spirit of the invention. For instance, dimensions such as diameters of the stones and areas of pavers can be changed to accommodate various walkway or path requirements. Likewise, different rubber or other durable elastomeric materials can be used to manufacture the products described herein. It is intended to claim all such changes and modifications as fall within the scope of the appended claims and their equivalents. Moreover, references herein to “top,” “bottom,” “upward,” “upper,” “higher,” “lower,” “downward,” “descending,” “ascending,” “side,”“first,” and “second” structures, elements, designations, geometries and the like are intended solely for purposes of providing an enabling disclosure and in no way suggest limitations regarding the operative orientation or order of the exemplary embodiments or any components thereof.

That which is claimed:

1. A rubber step, comprising:
a first side being configured for contacting ground, the first side having a first plurality of rubber components configured to appear as a first plurality of pebbles and a first cured color, the first cured color being cured with the first plurality of rubber components; and
a second side opposite the first side, the second side being configured for alternative contact with the ground, the second side having a second plurality of the rubber components configured to appear as a second plurality of pebbles and a second cured color different from the first color, the second cured color being cured with the second plurality of rubber components; and
a binder holding the respective first and second rubber components together.

2. The rubber step as in claim 1, wherein the rubber step is a rubber paver or a rubber stepping stone.

3. The rubber step as in claim 1, wherein the first and second colors are selected from the group consisting of red, white, brown, green, blue, sandstone or black, the first color being different from the second color.

4. The rubber step as in claim 1, wherein the first and second colors are derived from respective coloring pigments.

5. The rubber step as in claim 1, wherein the rubber step has a thickness of about 0.5 inches to about 1 inch.

6. The rubber step as in claim 1, wherein the rubber components are rubber granules.

7. The rubber step as in claim 6, wherein the rubber granules are derived from used rubber tires.

8. The rubber step as in claim 1, wherein the binder includes moisture curable urethane.

9. The rubber step as in claim 1, further comprising a curing catalyst and an anti-gloss agent.

10. The rubber step as in claim 1, further comprising an interlock being configured to mate the rubber step with a complementary rubber step.

11. A method of manufacturing a multi-colored rubber step, comprising:
providing a mold;
mixing together a rubber component, a binder and a first coloring agent to form a matrix having a first colored surface; and
introducing a second coloring agent onto the matrix to create a multicolored rubber step having a second colored surface opposite the first colored surface.

12. The method as in claim 11, wherein the mold defines a height of about one-half inch to about two inches, the height being about half a desired thickness of the rubber step.

13. The method as in claim 11, wherein the mold defines a diameter of about twelve inches to about forty inches.

14. The method as in claim 11, wherein the mold defines an area of about twelve square inches to about twenty square inches.

15. The method as in claim 11, further comprising leveling the rubber component, the binder and the first coloring agent.

16. The method as in claim 11, further comprising curing the rubber component, the binder and the first coloring agent.

17. The method as in claim 16, wherein the curing is accomplished by a chemical reaction.

18. The method as in claim 16, wherein the curing is accomplished by heat, compression, adhesive, and combinations thereof.

19. The method as in claim 11, further comprising mixing a plurality of fibers with the rubber component, the binder and the first coloring agent.

20. The method as in claim 11, further comprising mixing a catalyst with the rubber component, the binder and the first coloring agent.

21. The method as in claim 11, further comprising leveling the second coloring agent.

22. The method as in claim 11, further comprising curing the second coloring agent.

23. The method as in claim 11, further comprising joining the mold with a ring.

24. The method as in claim 231, wherein the mold includes a peripheral lip and a projection, the projection depending from the peripheral lip.

25. The method as in claim 23, wherein the ring includes a ledge defining a shoulder, the projection and the ledge complementarily shaped to seat the ring and the mold together.

26. The method as in claim 11, further comprising embossing one of the first and second colored surfaces such that each surface has a different texture.
